(19) United States
(12) Patent Application Publication
(10) Pub. No.: US 2006/0037178 A1
(43) Pub. Date: Feb. 23, 2006

(54) Self-adjusting tie-down strap

(76) Inventor: Michael S. Sulhoff, Cleveland, GA (US)

Correspondence Address: LITMAN LAW OFFICES, LTD, PO BOX 15035, CRYSTAL CITY STATION, ARLINGTON, VA, 22215, US

(21) Appl. No.: 11/206,127

(22) Filed: Aug. 18, 2005

Related U.S. Application Data
(60) Provisional application No. 60/602,656, filed on Aug. 19, 2004.

(51) Int. Cl. B25B 25/00

(52) U.S. Cl. 24/68 CD

(57) ABSTRACT

A self-adjusting, tie-down device that maintains consistent tension on loads in spite of shifting, settling or environmental change, i.e., hot/cold, dry/wet. The device includes a cam buckle assembly having a proximate end and a distal end. An inelastic strap is adjustably affixed to the distal end of the cam buckle. An elastic strap is pivotally attached at the proximate end of the cam buckle. Steel hooks are disposed at the respective free ends of the elastic and inelastic straps.

### CROSS-REFERENCE TO RELATED APPLICATION

This application claims the benefit of U.S. Provisional Patent Application Ser. No. 60/602,656, filed Aug. 19, 2004.

### BACKGROUND OF THE INVENTION

1. Field of the Invention

The present invention generally relates to securing devices. More specifically, the present invention is drawn to an adjustable strap for securing a load on a vehicle or the like, which strap will automatically adjust to maintain consistent tension on the load.

2. Description of the Related Art

Heretofore, firmly securing small-to-medium loads on a moving conveyance (car rack, truck bed, trailer, backpack, motorcycle, etc.) has been a no-win procedure in that shifting loads cause the tie-down strap to loosen. This scenario often requires that the user stop the vehicle and readjust the tension of the tie-down strap. Otherwise, the loads can be damaged or fall from the vehicle on the road or highway, thereby creating a hazardous situation. The art would certainly welcome a tie-down strap having a self-adjusting capability to obviate the above-described scenario.

The related art discloses tie-down devices that are self-adjusting. Pertinent examples of such related art are cited and identified in the accompanying IDS. However, none of the cited and identified inventions and patents, taken either singly or in combination, is seen to disclose a self-adjusting, tie-down strap as will be subsequently described and claimed in the instant invention. Thus, a self-adjusting tie-down strap solving the aforementioned problems is desired.

### SUMMARY OF THE INVENTION

The present invention is a self-adjusting, tie-down device that maintains consistent tension on loads in spite of shifting or settling. The device comprises a cam buckle assembly having a proximate end and a distal end. A non-elastic strap is adjustably affixed to the distal end of the cam buckle. An elastic strap is pivotally attached at the proximate end of the cam buckle. Steel hooks are disposed at the respective free ends of the elastic and inelastic straps.

Accordingly, the instant invention presents a device that provides a reliable tie-down for small, medium or large loads. The device is self-adjusting and will respond to shifting or shrinking loads whereby to securely retain the loads without overstressing. Non-complex and durable, the device is usable in a variety of tie-down scenarios.

The invention provides for improved elements thereof in an arrangement for the purposes described that are inexpensive, dependable and fully effective in accomplishing their intended purposes.

A clear understanding of the present invention will become readily apparent upon further review of the following specification and drawings.

### BRIEF DESCRIPTION OF THE DRAWINGS

FIG. 1 is an environmental, perspective view of a self-adjusting tie-down strap according to the present invention.

FIG. 2 is a perspective view of a self-adjusting tie-down strap according to the present invention.

FIG. 3 is a perspective view of an elastic strap for a self-adjusting tie-down strap according to the present invention.

FIG. 4 is a partial, exploded view of the “S” hook and elastic strap for a self-adjusting tie-down strap according to the present invention.

FIG. 5 is a partial, exploded view of the cam buckle and elastic strap for a self-adjusting tie-down strap according to the present invention.

Similar reference characters denote corresponding features consistently throughout the attached drawings.

### DETAILED DESCRIPTION OF THE PREFERRED EMBODIMENT

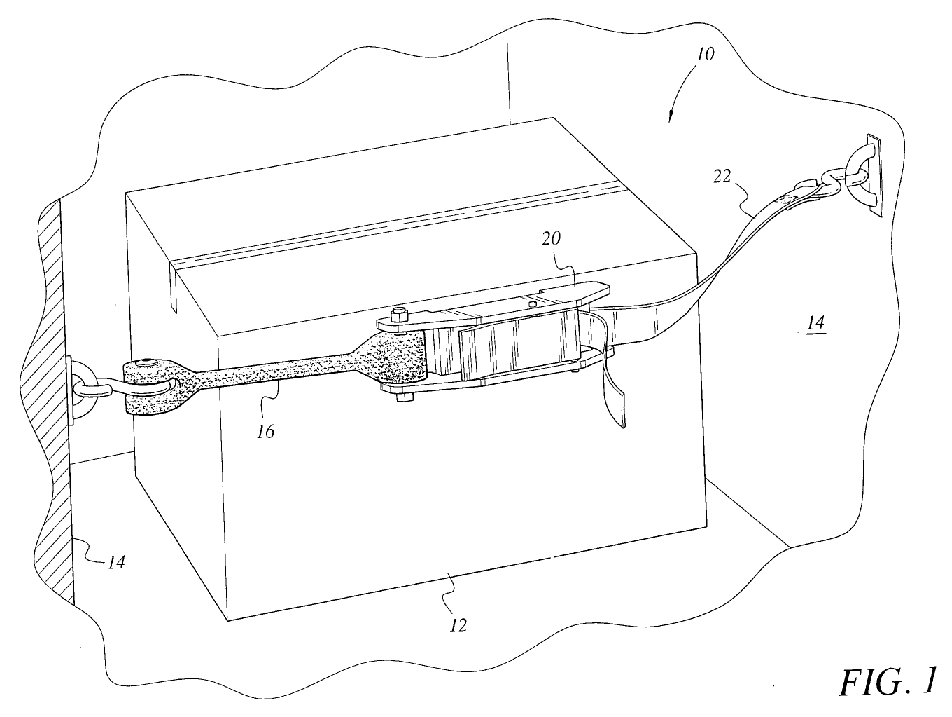

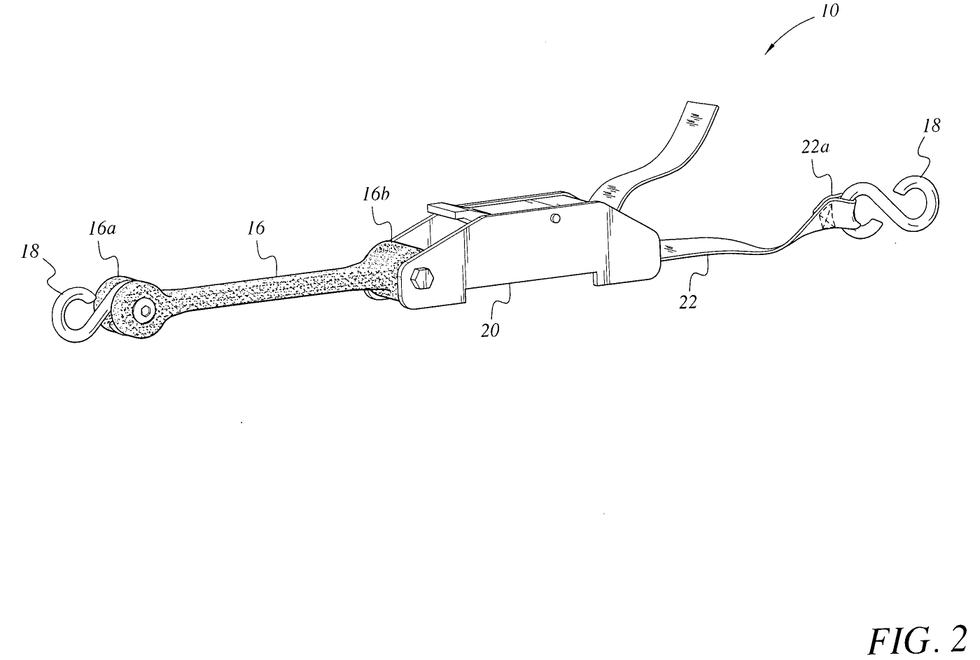

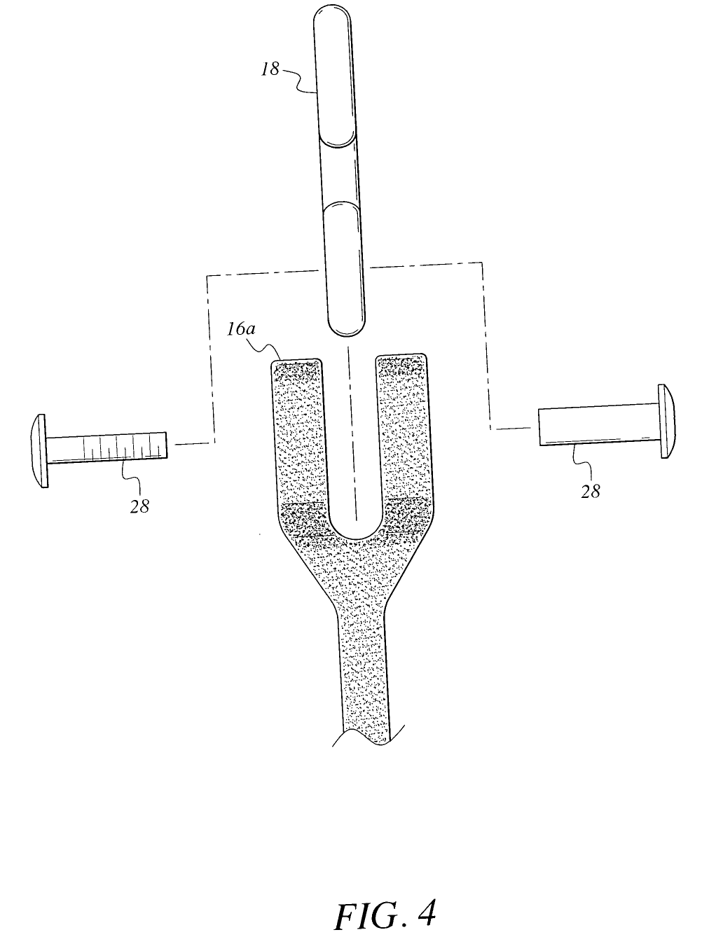

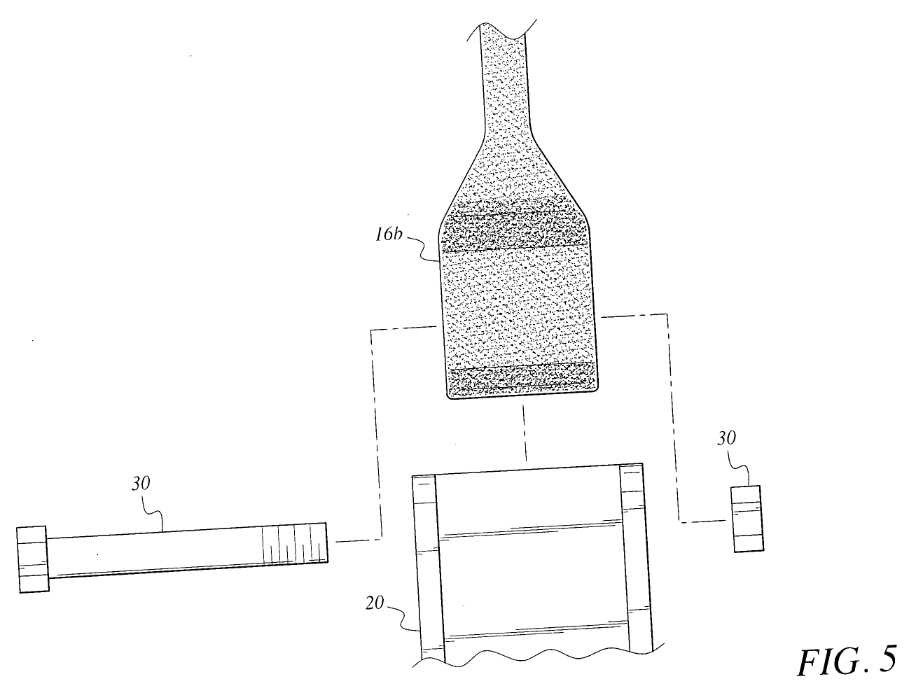

Attention is directed to FIGS. 1-5 wherein the tie-down device of the present invention is generally indicated at 10. The device 10 is employed to secure a load 12 to the walls 14 of a pick-up truck or the like. Tie-down device 10 comprises a strap 16 fabricated from a suitable elastic material (bungee cord material, for example). A steel S-shaped hook 18 is pivotally attached to the distal end 16a of strap 16. The proximate end 16b is pivotally secured to a first end of a tightening mechanism, such as a cam buckle 20. A flat, non-elastic strap 22 is adjustably secured along its length to a second end of cam buckle 20. A free end 22a of strap 22 terminates in a second S-shaped hook 18.

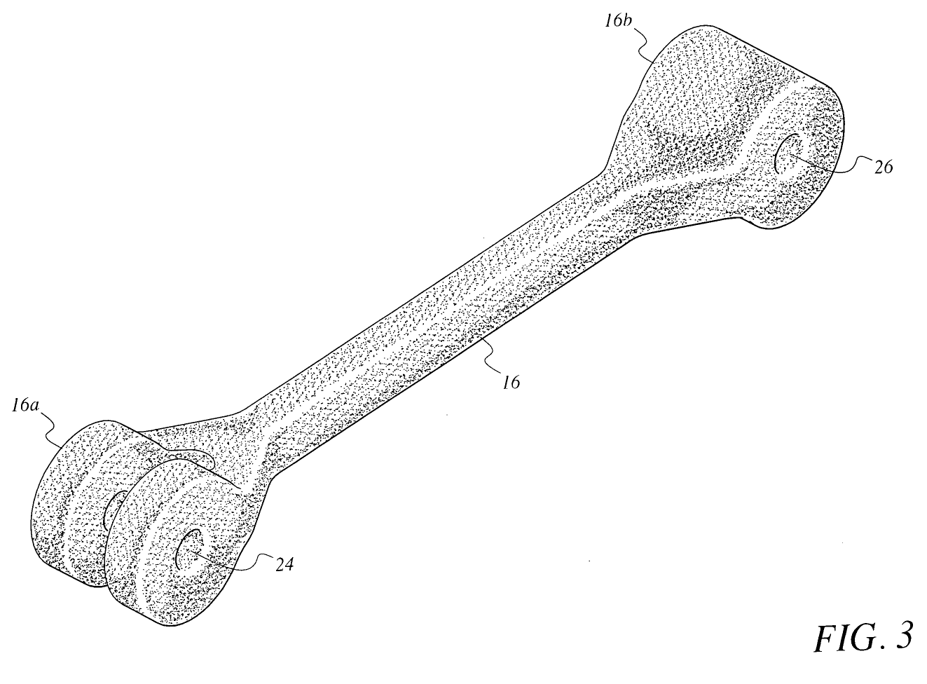

Non-elastic strap 22 is fabricated from any durable and suitable material (synthetic or natural). As best seen in FIGS. 3-5, elastic strap 16 is provided with openings 24 and 26 whereby conventional fasteners 28 and 30 are utilized to accomplish the respective pivoting attachments to the S-shaped hook and cam buckle.

The length of the elastic strap relative to the total length of the adjusted device is an important consideration in determining the effectiveness of the device. For example, the elastic strap gives the device the ability to better accommodate loads that may shift or shrink. The non-elastic strap exhibits greater strength and is effective for more massive loads. It has been determined that the elastic strap should have a length less than one-half the overall length of the working length of the device for optimum effectiveness. The working length is defined as the combined total length of the elastic strap, the tightening mechanism, and the adjusted non-elastic strap. The width or thickness of the straps will be selected based on the type load to be secured. For example, ¼ inch wide straps would be sufficient for extremely small and light loads (backpacks, bicycle rack tie-downs, etc.), whereas large loads (logs, lumber, appliances, etc.) would require 2-inch wide straps. Although the tightening mechanism is referred to as a cam buckle, it is obvious that other devices (heavy-duty ratchets, lever-locking devices, etc.) could be utilized if necessary or desired.

It is to be understood that the present invention is not limited to the embodiment described above, but encompasses any and all embodiments within the scope of the following claims.

I claim:

1. A self-adjusting tie-down device having a working length, the device comprising:
a tightening mechanism, said tightening mechanism having a length;
a non-elastic strap, said non-elastic strap being adjustably secured to said tightening mechanism, said non-elastic strap having an adjusted length;
an elastic strap having a length, a distal end and a proximate end, the proximate end of said elastic strap being secured to said tightening mechanism, the device having a working length equal to the combined total length of the elastic strap, the tightening mechanism, and the adjusted non-elastic strap, the length of said elastic strap being less than one-half the working length of the device.

2. The self-adjusting tie-down device as recited in claim 1, further including a hook member attached to the distal end of said elastic strap.

3. The self-adjusting tie-down device as recited in claim 1, wherein said non-elastic strap has a free end, the device further including a hook member attached to the free end of said non-elastic strap.

4. The self-adjusting tie-down device as recited in claim 1, wherein said tightening member has a first end and a second end and wherein the proximate end of said elastic strap is secured to the first end and said non-elastic strap is adjustably secured to the second end.

5. A self-adjusting tie-down device, comprising:
a tightening mechanism, said tightening mechanism having a length;
a non-elastic strap, said non-elastic strap being adjustably secured to said tightening mechanism, said non-elastic strap having an adjusted length;
an elastic strap having a length, a distal end and a proximate end, the proximate end of said elastic strap being secured to said tightening mechanism, wherein the length of said elastic strap is less than one half the combined total length of said tightening mechanism and said non-elastic strap.

6. The self-adjusting tie-down device as recited in claim 5, further including a hook member attached to the distal end of said elastic strap.

7. The self-adjusting tie-down device as recited in claim 5, wherein said non-elastic strap has a free end, the device further including a hook member attached to the free end.

8. The self-adjusting tie-down device as recited in claim 5, wherein said tightening member has a first end and a second end and wherein the proximate end of said elastic strap is secured to the first end and said non-elastic strap is adjustably secured to the second end.

9. A self-adjusting tie-down device, comprising:
a tightening mechanism, said tightening mechanism having a length, a first end and a second end;
a non-elastic strap, said non-elastic strap being adjustably secured to said tightening mechanism at the second end of said tightening mechanism, said non-elastic strap having an adjusted length;
an elastic strap having a length, a distal end and a proximate end, the proximate end of said elastic strap being pivotally secured to the first end of said tightening mechanism, the length of said elastic strap being less than one half the combined total length of said tightening mechanism, the adjusted length of said non-elastic strap and the length of said elastic strap.

10. The self-adjusting tie-down device as recited in claim 9, further including a hook member attached to the distal end of said elastic strap.

11. The self-adjusting tie-down device as recited in claim 9, wherein said non-elastic strap has a free end, the device further including a hook member attached to said free end.
